(19) United States
(12) Patent Application Publication
(10) Pub. No.: US 2017/0171293 A1
(43) Pub. Date: Jun. 15, 2017

(54) COMPACT CONTENT DELIVERY VIA A RESTRICTED-BANDWIDTH COMMUNICATION CHANNEL

(71) Applicant: OCENS, Inc., Des Moines, WA (US)

(72) Inventors: Jeff Thomassen, Port Orchard, WA (US); Scott Johnson, University Place, WA (US); Mark Freeberg, Normandy Park, WA (US)

(21) Appl. No.: 14/968,640

(22) Filed: Dec. 14, 2015

(51) Int. Cl. H04L 29/08; H04L 29/06

(52) U.S. Cl. CPC H04L 67/06; H04L 67/42

(57) ABSTRACT

A system is disclosed for providing compact metadata and compact content via a restricted-bandwidth communication channel using a two-phase approach. In the first phase, the system retrieves from a content provider metadata of the content instances to which the user has access rights via a communication channel. The system then compacts the metadata for the content instances and sends the compact metadata to the user's client via the restricted-bandwidth communication channel. In the second phase, the system receives from the client an indication of a specified content instance. The system retrieves from the content provider the content of the specified instance via the communication channel. The system compacts the retrieved content and sends it to the client via a restricted-bandwidth communication channel.

### BACKGROUND

As the bandwidth of electronic communications channels continues to increase, content providers take advantage of the increased bandwidth by delivering more and more content and at higher resolutions. For example, a video streaming service that once transmitted video only in an SDTV format may now transmit videos in an HDTV format. As another example, an electronic mail service may allow electronic mail messages to have very large bodies and many large attachments (e.g., many very high-resolution images).

Content providers provide interfaces that take advantage of the increasing bandwidth. For example, when a smartphone of a user connects (e.g., via a cellular or WiFi network) to an interface of an electronic mail service, the service may download to the smartphone all the content of the user's inbox, which typically includes, for each electronic mail message, header information, the body of the message, and attachments. The user can then view the downloaded content at a later time even when not connected to a network. Some electronic mail services may provide a web interface through which a web page is initially downloaded that includes header information for all the messages in the user's inbox and then, when a message is selected, a web page is downloaded that includes the body of the selected message and links to attachments. As another example, when the smartphone connects to an interface of a video service, the service may download only HDTV videos.

Although the interfaces provided by such content providers take advantage of high bandwidth, not all communication channels, referred to as “restricted-bandwidth communication channels,” can support a high effective bandwidth. A communication channel may be considered bandwidth restricted for several reasons. For example, a communication channel may be considered bandwidth restricted if its bandwidth is less than the bandwidth that a content provider can support. As another example, even a high-bandwidth communication channel may be effectively bandwidth restricted if the cost of sending content via the high-bandwidth communication channel is so high as to be an effective restriction on the bandwidth that can be used. As another example, when many devices use the same high-bandwidth communication channel, the communication channel may be effectively bandwidth restricted for each device. As another example, if a high-bandwidth communication channel is used by a device that is nearly out of the communication channel's range or that is used in an environment (e.g., noisy) where reception is otherwise poor, the communication channel may be effectively bandwidth restricted. One example of a restricted-bandwidth communication channel may be a satellite phone communication channel. A satellite phone communication channel may be restricted to sending content at low rates relative to the rates at which a content provider can send content. Even if a satellite phone communication channel did support a higher bandwidth, the cost of sending content might be so high as to be an effective restriction on the bandwidth that can be used. Another example of a restricted-bandwidth communication channel may be a cellular phone communication channel. The bandwidth of a cellular phone communication channel may be bandwidth restricted because the transmission rate is low relative to other communication channels or because a smartphone is being used in a geographic location where reception is poor. Because of this restricted bandwidth, it is problematic for a device to access the content of content providers who have designed their interfaces to take advantage of high-bandwidth communication channels. For example, it may take a prohibitively long time or be prohibitively expensive to download even a web page that just contains the header information for all the messages in a user's inbox or to download a web page for a single email message whose content is only one word because the HTML document defining the web page may include thousands of characters to fully specify the format and content of the web page. It would take an even longer time or be more costly to download all the content of the inbox or to download even a short HDTV video of a web page.

### BRIEF DESCRIPTION OF THE DRAWINGS

FIG. 1 is a flow diagram that illustrates overall processing of a content intermediary server in some embodiments.

FIG. 2 is a communications flow diagram illustrating acquisition of a refresh token in some embodiments.

FIG. 3 is a communications flow diagram illustrating retrieval of metadata in some embodiments.

FIG. 4 is a communications flow diagram illustrating retrieval of content in some embodiments.

FIG. 5 is a block diagram that illustrates components of a content intermediary system in some embodiments.

FIG. 6 is a flow diagram that illustrates the processing of a configure component of the content intermediary client in some embodiments.

FIG. 7 is a flow diagram that illustrates the processing of a configure component of a content intermediary server in some embodiments.

FIG. 8 is a flow diagram that illustrates processing of a process client request component in some embodiments.

FIG. 9 is a flow diagram that illustrates processing of a compact metadata component of a content intermediary server in some embodiments.

FIG. 10 is a flow diagram that illustrates the processing of a compact content component of a content intermediary server in some embodiments.

### DETAILED DESCRIPTION

A method and system for providing delivery of compact content via a restricted-bandwidth communication channel is provided. In some embodiments, a content intermediary system provides a content intermediary server for delivery of compact content of a content provider to a content intermediary client of the content intermediary server. The content intermediary server provides to the content intermediary client metadata for content instances of content provided by the content provider. For example, a content provider may be an email provider, a content instance may be an email message, and metadata may be header information for the email messages. To provide metadata, the content intermediary server retrieves from a content provider server metadata for content instances. For example, the server metadata from an email message may include attributes such as from information, cc information, to information, subject, size, time sent, time received, message identifier, priority flag, read status, attachment information, and so on. The content intermediary server then generates compact metadata from the retrieved metadata with a size that is smaller (e.g., fewer characters) than the retrieved metadata. For example, the compact metadata may include only key attributes (e.g., from information, subject, size, and message identifier) and may include metadata only for email messages that are marked as unread. A key attribute for a content instance is an attribute that a user would need to make an informed decision on whether to download the content instance over a restricted-bandwidth communication channel. As another example, the content intermediary server may apply one or more compression techniques (e.g., bzip2, Lempel-Ziv, or gzip) to the key attributes to generate the compact metadata. In some embodiments, the compact metadata may include all the metadata in a compressed form. The content intermediary server then sends to the content intermediary client the compact metadata via the restricted-bandwidth communication channel. If a user decides that the key attributes do not provide enough information to make an informed decision, the content intermediary client may request the content intermediary server to provide attributes other than the key attributes. In this way, the content intermediary server provides compact metadata to allow a user to decide whether to download the content instance.

After the content intermediary client receives the compact metadata, the user may decide to download selected content instances. In response to receiving from the content intermediary client a request for content of a specified content instance, the content intermediary server provides to the content intermediary client content of the specified content instance. For example, if the metadata includes header information for 20 email messages, the user may specify three email messages and the content intermediary server then downloads the body of those three email messages from the email server. To provide the content, the content intermediary server retrieves from the content provider the content of the specified content instance. The specified content instance may be identified by its message identifier, which may be assigned by the content provider to uniquely identify a content instance. For example, the request may include the message identifiers of the three email messages, which the content intermediary server provides to the content provider server. The content intermediary server then generates compact content from the retrieved content that has a size that is smaller than the retrieved content. For example, the content intermediary server may compress the content using one or more compression techniques such as lossless compression techniques for text and lossy compression techniques for video and images. The content intermediary server then sends to the content intermediary client the compact content via the restricted-bandwidth communication channel. By using a two-phase approach that first provides compact metadata for key attributes and then provides compact content for only the specified content, the content intermediary system helps reduce the amount of data that is sent via the restricted-bandwidth communication channel.

In some embodiments, the content intermediary system transmits data between the content intermediary server and the content intermediary client in a secure manner using encryption. For example, the content intermediary server may encrypt data (e.g., compact metadata and compact content) to be sent to the content intermediary client using a public key of the content intermediary client so that the content intermediary client can decrypt the data using its private key. Similarly, the content intermediary client may encrypt data to be sent to the content intermediary server using the public key of the content intermediary server so that the content intermediary server can decrypt the data using its private key. The transmission of data between the content intermediary server and the content provider server may also be secured using a mechanism established by the content provider server such as Transport Layer Security or Secure Sockets Layer.

In some embodiments, the content information system allows a user of a content intermediary client to be authenticated directly with the content provider and to delegate to the content intermediary server access rights to content of the content provider without providing complete content provider credentials of the user to the content intermediary server. The content provider credentials may include a user name and password. To support authenticating a user, the content intermediary server receives from the content intermediary client an identification (e.g., user name) used by the content provider to identify the user and sends to a content provider authorization service a request to authenticate the user and authorize the user to access content of the content provider. The content intermediary system may use the OAuth 2.0 protocol for authentication and delegation. OAuth 2.0 is described in “The OAuth 2.0 Authorization Framework,” Internet Engineering Task Force, RFC 6749, October 2012, which is hereby incorporated by reference. The content intermediary server receives from the content provider authorization service submission information (e.g., an authentication uniform resource locator) for use by the content intermediary client in authenticating with the content provider authorization service. The content intermediary server sends to the content intermediary client the received submission information so that the user can provide content provider credentials of the user directly to the content provider authorization service and the content intermediary client can receive an authorization token (e.g., a refresh token when using OAuth 2.0) indicating that the user is authorized to access content of the content provider. The content intermediary client stores the authorization token and provides it to the content intermediary server when metadata or content is to be retrieved. The content intermediary server provides the authorization token to retrieve data from the content provider server. When the OAuth 2.0 protocol is used, the content intermediary server provides a refresh token to the authorization service, receives an access token, and provides that access token to the content provider server when retrieving data that the user is authorized to access.

In some embodiments, the content intermediary system includes client code that executes on a content intermediary client and server code that executes on a content intermediary server. The client code may be distributed to content intermediary clients via an application store. An application store is a digital distribution platform that allows application providers to make the client code of their applications available for download to clients. When registering client code of the content intermediary system with an application store, the application store provides an application identifier and an application secret. The application identifier and application secret are used as credentials for the content provider authorization service. To download the client code to a content intermediary client, a user accesses the application store with the content intermediary client and downloads the client code. When the client code is downloaded, the application store records that the user has downloaded that client code by mapping the user's user name to the client code. This mapping serves as an indication that the user may be delegating access rights to the content intermediary server. In this way, the content provider authorization service can confirm that the request is from the content intermediary server to which the user has indicated an intent to delegate access rights.

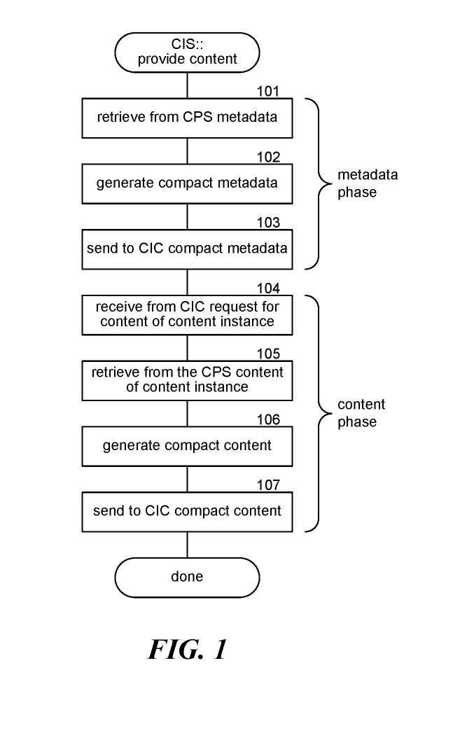

FIG. 1 is a flow diagram that illustrates overall processing of a content intermediary server in some embodiments. As described above, the content intermediary server uses a two-phase approach for providing content to a content intermediary client. Blocks 101-103 illustrate the first phase, referred to as a “metadata phase,” and blocks 104-107 illustrate the second phase, referred to as a “content phase.” In block 101, the content intermediary server retrieves metadata from the content provider server. Although not illustrated, the content intermediary server may have received a request from a content intermediary client requesting retrieval of metadata. In block 102, the content intermediary server generates compact metadata from the retrieved metadata. In block 103, the content intermediary server sends the compact metadata to the content intermediary client. In block 104, the content intermediary server receives a request for content of a specified content instance from the content intermediary client. In block 105, the content intermediary server retrieves the content of the specified instance from the content provider server. In block 106, the content intermediary server generates compact content from the retrieved content. In block 107, the content intermediary server sends the compact content to the content intermediary client and then completes.

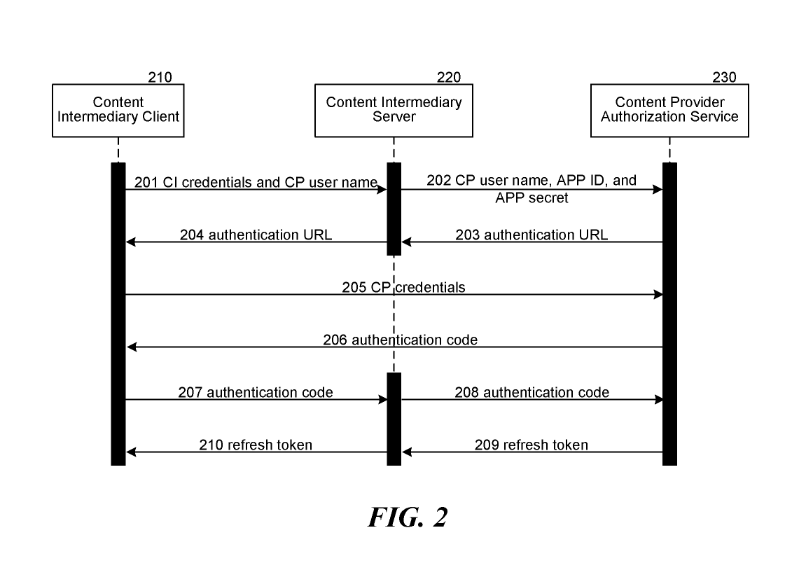

FIG. 2 is a communications flow diagram illustrating acquisition of a refresh token in some embodiments. The diagram illustrates communications between a content intermediary client 210, a content intermediary server 220, and a content provider authorization service 230. The content intermediary client initially sends 201 to the content intermediary server a request to delegate access rights. The request includes the content intermediary credentials of the user and the content provider user name of the user. After authenticating the user, the content intermediary server sends 202 to the content provider authorization service a request for a refresh token. The request includes the application identifier (and the application secret if needed for authentication) of the content intermediary server and the content provider user name. After confirming that the user has indicated an intent to delegate to the client intermediary server, the content provider authorization service sends 203 to the content intermediary server an authentication uniform resource locator (“URL”) for authenticating the user. The content intermediary server then sends 204 to the content intermediary client the authentication uniform resource locator. The content intermediary server receives the content provider credentials from the user and sends 205 the content provider credentials to the content provider authorization service indicating that the user is delegating access rights to the content intermediary server. The content provider authorization service then sends 206 an authentication code to the content intermediary client. The content intermediary client then sends 207 a request for a refresh token to the content intermediary server. The request includes the authentication code. The content intermediary server sends 208 the request for the refresh token to the content provider authorization service. The content provider authorization service then sends 209 a refresh token to the content intermediary server. The content intermediary server then sends 210 the refresh token to the content intermediary client, which the content intermediary client can provide to the content intermediary server to delegate access as needed.

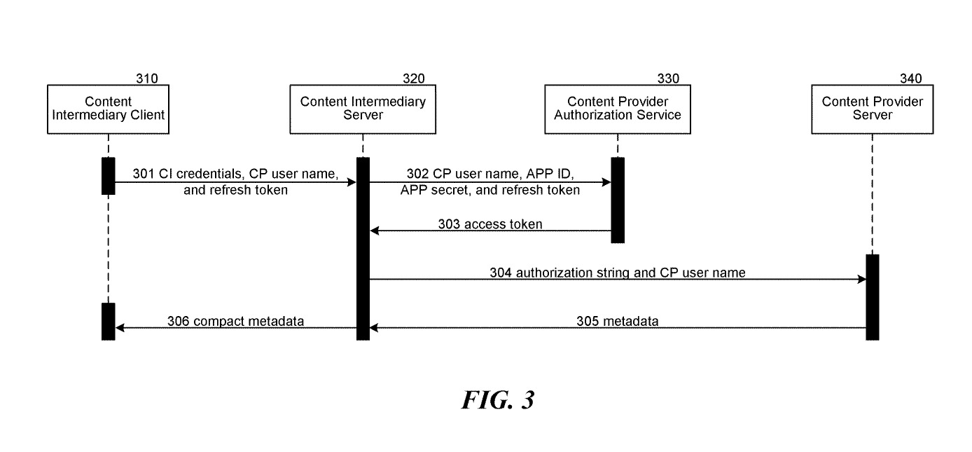

FIG. 3 is a communications flow diagram illustrating retrieval of metadata in some embodiments. The diagram illustrates communications between a content intermediary client 310, a content intermediary server 320, a content provider authorization service 330, and a content provider server 340. The content intermediary client initially sends 301 to the content intermediary server a request for metadata. The request includes the content intermediary credentials of the user, the content provider user name of the user, and a refresh token. After authenticating the user, the content intermediary server sends 302 to the content provider authorization service a request for an access token. The request includes the application identifier (and the application secret if needed for authentication) of the content intermediary server, the content provider user name, and the refresh token. The content provider authorization service creates the access token based on the refresh token and sends 303 to the content intermediary server the access token. The content intermediary server generates an authorization string based on the access token and sends 304 to the content provider server a request for the metadata (e.g., headers of unread email messages). The request includes the authorization string. The content provider server sends 305 to the content intermediary server the metadata. The content intermediary server then generates compact metadata and sends 306 the compact metadata to the content intermediary client.

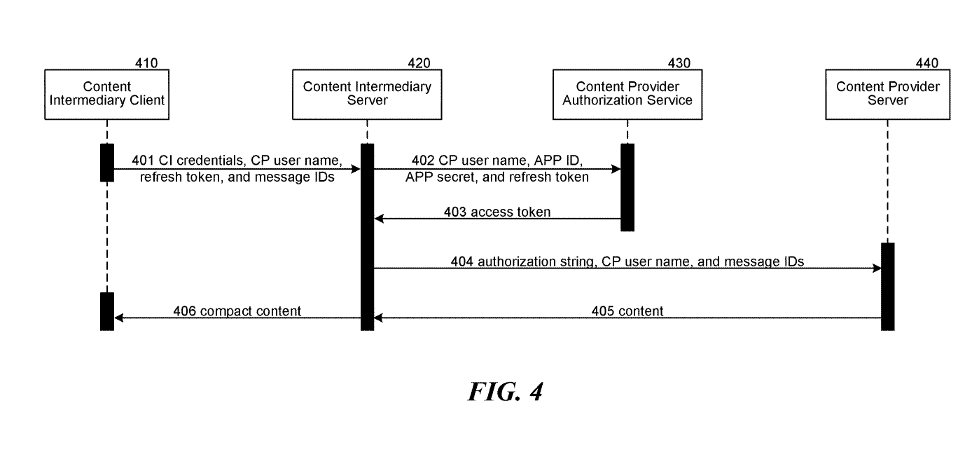

FIG. 4 is a communications flow diagram illustrating retrieval of content in some embodiments. The diagram illustrates communications between a content intermediary client 410, a content intermediary server 420, a content provider authorization service 430, and a content provider server 440. The content intermediary client initially sends 401 to the content intermediary server a request for content of a content instance. The request includes the content intermediary credentials of the user, the content provider user name of the user, the refresh token, and message identifiers of the content instances whose content is to be retrieved. After authenticating the user, the content intermediary server sends 402 to the content provider authorization service a request for an access token. The request includes the application identifier (and the application secret if needed for authentication) of the content intermediary system, the content provider user name, and the refresh token. The authorization service creates the access token based on the refresh token and sends 403 to the content intermediary server the access token. The content intermediary server generates an authorization string based on the access token and sends 404 to the content provider server a request for the content of the specified content instances. The request includes the authorization string and the message identifiers of the specified content instances. The content provider server sends 405 the content to the content intermediary server. The content intermediary server then generates the compact content and sends 406 the compact content to the content intermediary client.

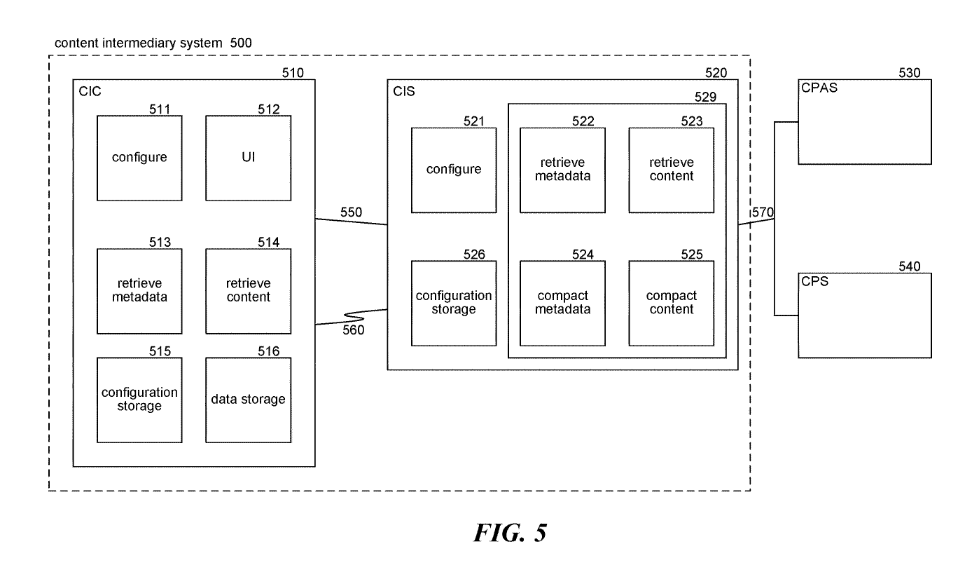

FIG. 5 is a block diagram that illustrates components of a content intermediary system in some embodiments. The content intermediary system 500 includes client code that executes on content intermediary client (“CIC”) 510 and server code that executes on content intermediary server (“CIS”) 520. The content intermediary client communicates with the content intermediary server via communication channel 550 during configuration and restricted-bandwidth communication channel 560 when retrieving metadata and content. Because the one-time configuration may involve transmitting significant amounts of data, it may be desirable to configure a content intermediary client using a communication channel other than a bandwidth-restricted communication channel. In other embodiments, the content intermediary client may only be able to communicate via a restricted-bandwidth communication channel. In such a case, all communications including the one-time configuration would be via that channel. The content intermediary server communicates with the content provider authorization service (“CPAS”) 530 and the content provider server (“CPS”) 540 via communication channel 570.

The client code includes a configure component 511, a user interface component 512, a retrieve metadata component 513, and a retrieve content component 514. The client code also persistently stores configuration information in a configuration storage 515 and may persistently store downloaded metadata and content in a data storage 516. The configure component configures the content intermediary client with a refresh token, which is stored in the configuration storage. The retrieve metadata component is invoked to retrieve metadata from the content provider. The retrieve content component is invoked to retrieve content from the content provider. The user interface component provides the user interface for displaying metadata and content. For example, if the content is email messages, then the user interface may be similar to a conventional email user interface. If the content is video data of a video service, the metadata may include video name, size information, scene information, scene size, and so on. The user interface may display the scene information so a user may specify to download only certain scenes of the video. If the content is files of a file server, the metadata may include file name, file size, author, summary information, and so on. The user interface may display the file name and file size of all the files that have not yet been downloaded and allow the user to select files to be downloaded.

The server code includes a configure component 521 and a process client request component that includes a retrieve metadata component 522, a retrieve content component 523, a compact metadata component 524, and a compact content component 525. The server code also stores configuration information in configuration storage 526. The configure component supports the configuring of a content intermediary client with a refresh key. The retrieve metadata component and the retrieve content component retrieve metadata and content from the content provider server when requested by the content intermediary client. The compact metadata component and the compact content component compact the retrieved metadata and content. The configuration storage stores configuration information such as the application identifier and application secret.

The content provider authorization server provides refresh and access tokens. The content provider server provides metadata and content that a user authorized the content provider server to access.

The computing systems on which the content intermediary system may be implemented may include a central processing unit, input devices, output devices (e.g., display devices and speakers), storage devices (e.g., memory and disk drives), network interfaces, graphics processing units, accelerometers, cellular radio link interfaces, global positioning system devices, satellite data links, and so on. The input devices may include keyboards, pointing devices, touch screens, gesture recognition devices (e.g., for air gestures), head and eye tracking devices, microphones for voice recognition, and so on. A client is a computing system that may be a desktop computer, a laptop, a tablet, an e-reader, a personal digital assistant, a smartphone, a gaming device, and so on. A server is a computing system that may be a computer of a data center, a computer of a massively parallel system, and so on. The computing systems may access computer-readable media that include computer-readable storage media and data transmission media. The computer-readable storage media are tangible storage means that do not include a transitory, propagating signal. Examples of computer-readable storage media include memory such as primary memory, cache memory, and secondary memory (e.g., DVD) and other storage. The computer-readable storage media may have recorded on it or may be encoded with computer-executable instructions or logic that implements the content intermediary system. The data transmission media is used for transmitting data via transitory, propagating signals or carrier waves (e.g., electromagnetism) via a wired or wireless connection. The computing systems may include a secure cryptoprocessor as part of a central processing unit for generating and securely storing keys and for encrypting and decrypting data using the keys. The communication channels may include wired and wireless channels. The wireless channels may include WiFi channels, satellite channels, cellular channels, and so on.

The content intermediary system may be described in the general context of computer-executable instructions, such as program modules and components, executed by one or more computers, processors, or other devices. Generally, program modules or components include routines, programs, objects, data structures, and so on that perform particular tasks or implement particular data types. Typically, the functionality of the program modules may be combined or distributed as desired in various examples. Aspects of the content intermediary system may be implemented in hardware using, for example, an application-specific integrated circuit (ASIC).

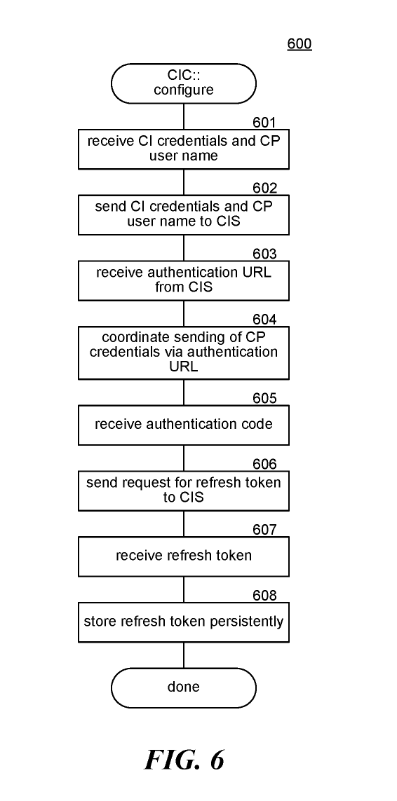

FIG. 6 is a flow diagram that illustrates the processing of a configure component of the content intermediary client in some embodiments. A configure component 600 controls the configuring of the content intermediary client with a refresh token for use in accessing the content provider server. In block 601, the component receives content intermediary credentials and a content provider user name of the user. In block 602, the component sends the content intermediary credentials and the content provider user name to the content intermediary server. In block 603, the component receives an authentication URL from the content intermediary server. In block 604, the component coordinates the sending of content provider credentials based on the authentication URL. In block 605, the component receives an authentication code from the content provider authorization service. In block 606, the component sends a request for a refresh token to the content intermediary server, which forwards the request to the content provider authorization service and receives the refresh token in response. In block 607, the component receives the refresh token from the content intermediary server. In block 608, the component stores the refresh token persistently in the configuration store of the content intermediary client and then completes.

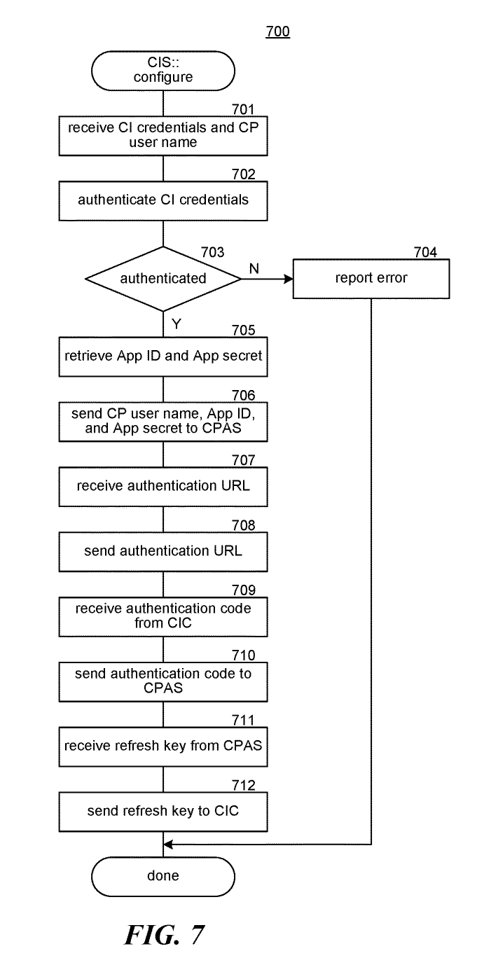

FIG. 7 is a flow diagram that illustrates the processing of a configure component of a content intermediary server in some embodiments. A configure component 700 assists in configuring a content intermediary client with a refresh token. In block 701, the component receives content intermediary credentials and a content provider user name from a content intermediary client. In block 702, the component authenticates the content intermediary credentials. In decision block 703, if the content intermediary credentials have been authenticated, then the component continues at block 705, else the component reports an error in block 704 and then completes. In block 705, the component retrieves from the configuration store the application identifier and application secret issued to the content intermediary server by the content provider authorization service. In block 706, the component sends the content provider user name, the application identifier, and the application secret to the content provider authorization service. In block 707, the component receives an authentication URL from the content provider authorization service. In block 708, the component sends the authentication URL to the content intermediary client. In block 709, the component receives a request for a refresh key along with an authentication code from the content intermediary client. In block 710, the component sends the request to the content provider authorization service. In block 711, the component receives the refresh key from the content provider authorization service. In block 712, the component sends the refresh key to the content intermediary client and then completes.

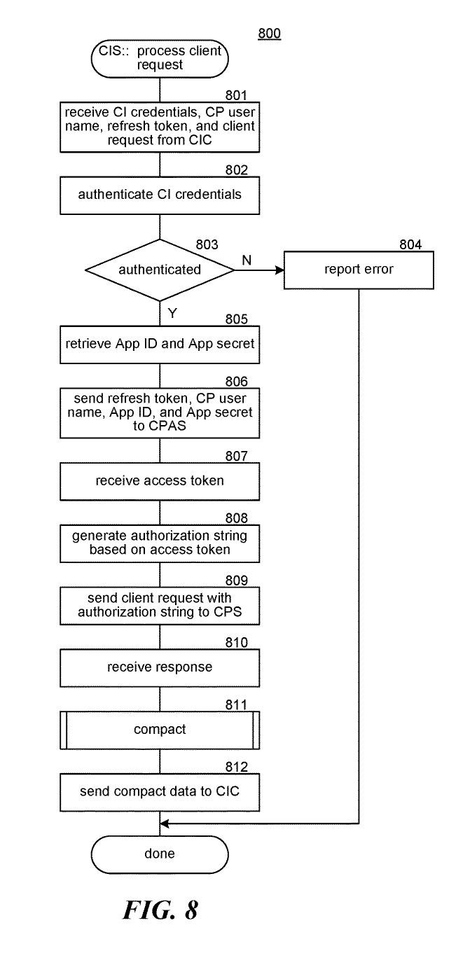

FIG. 8 is a flow diagram that illustrates processing of a process client request component in some embodiments. A process client request component 800 receives a request for data (e.g., metadata or content) from a contact intermediary client, retrieves the data from a content provider server, and sends compact data to the content intermediary client. In block 801, the component receives a request for content provider data that includes content intermediary credentials and a content provider user name of a user, a refresh token, and a client request. The client request may be either for metadata or for specified content. In block 802, the component authenticates the content intermediary credentials. In decision block 803, if the credentials have been authenticated, then the component continues at block 805, else the component reports an error in block 804 and then completes. In block 805, the component retrieves an application identifier and application secret from the configuration storage. In block 806, the component sends the refresh token, content provider user name, application identifier, and application secret to the content provider authorization service. In block 807, the component receives an access token from the content provider authorization service. In block 808, the component generates an authorization string based on the access token. In block 809, the component sends the client request with the authorization string to the content provider server. In block 810, the component receives a response. In block 811, the component invokes a compact component to compact the data received from the content provider server, depending on whether metadata or content was requested. In block 812, the component sends the compact data to the content intermediary client and then completes.

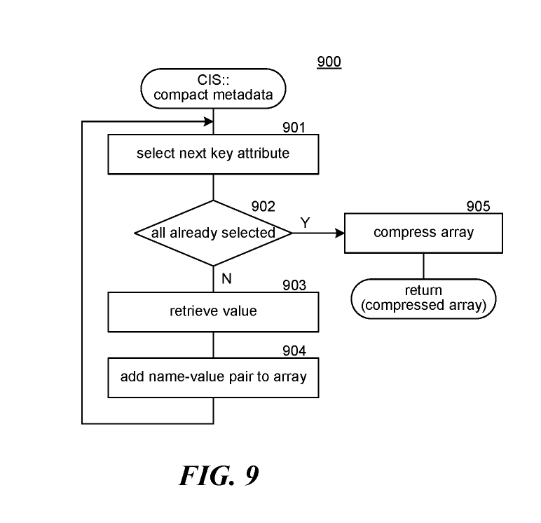

FIG. 9 is a flow diagram that illustrates processing of a compact metadata component of a content intermediary server in some embodiments. A compact metadata component 900 extracts key attributes from the metadata and compresses the key attributes. In block 901, the component selects the next key attribute. In decision block 902, if all the key attributes have already been selected, then the component continues at block 905, else the component continues at block 903. In block 903, the component retrieves the value for that attribute from the metadata. In block 904, the component adds a name-value pair for that attribute to an array of key attributes. For example, the array may be a Java Script Object Notation (“JSON”) array. Alternatively, the array may only contain the values of the key attributes in a predefined order without attribute names. The component then loops to block 901 to select the next key attribute. In block 905, the component compresses the array and returns the compressed array.

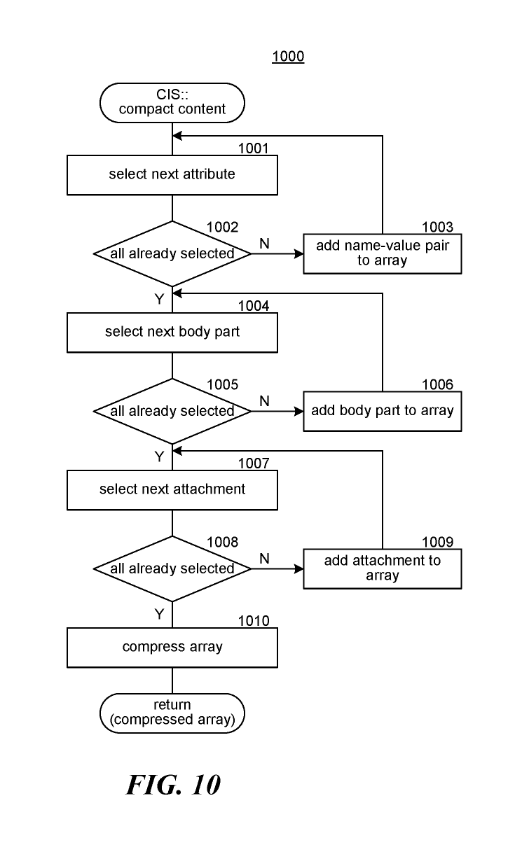

FIG. 10 is a flow diagram that illustrates the processing of a compact content component of a content intermediary server in some embodiments. A compact content component 1000 may create an array (e.g., a JSON array) that contains the content for a content instance that may include a header, body parts (e.g., video frames), and attachments and then compresses the array. In block 1001, the component selects the next attribute of metadata. In decision block 1002, if all the attributes have already been selected, then the component continues at block 1004, else the component continues at block 1003. In block 1003, the component adds a name-value pair for the attribute to the array and then loops to block 1001 to select the next attribute. In block 1004, the component selects the next body part of the content. In decision block 1005, if all the body parts have already been selected, then the component continues at block 1007, else the component continues at block 1006. In block 1006, the component adds the body part to the array and then loops to block 1004 to select the next body part. In block 1007, the component selects the next attachment for the content. In decision block 1008, if all the attachments have already been selected, then the component continues at block 1010, else the component continues at block 1009. In block 1009, the component adds the attachment to the array and then loops to block 1007 to select the next attachment. In block 1010, the component compresses the array and then returns the compressed array. In some embodiments, the component may generate the compact data by, for example, applying a lossy compression algorithm to an image or a video. For example, the component may convert a video in HDTV format to an SDTV format.

Although the subject matter has been described in language specific to structural features and/or acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method performed by a content intermediary server for providing content to a content intermediary client, the method comprising:
providing to the content intermediary client metadata for content instances by:
retrieving from a content provider server metadata for content instances;
generating compact metadata from the retrieved metadata, the compact metadata having a size that is smaller than the retrieved metadata;
sending to the content intermediary client the compact metadata; and
in response to receiving from the content intermediary client a request for content of a specified content instance, providing to the content intermediary client content of the specified content instance by:
retrieving from the content provider server content of the specified content instance;
generating compact content from the retrieved content, the compact content having a size that is smaller than retrieved content; and
sending to the content intermediary client the compact content;
wherein the content intermediary client receives the compact metadata and the compact content via a restricted-bandwidth communication channel.

2. The method of claim 1 wherein the generating of the compact metadata includes extracting values for key attributes of the retrieved metadata and compressing the extracted values.

3. The method of claim 1 wherein the generating of the compact content includes compressing the retrieved content.

4. The method of claim 3 wherein the compression is lossy.

5. The method of claim 3 wherein the compression is loseless.

6. The method of claim 1 wherein communications between the content intermediary server and the content intermediary client and between the content intermediary server and the content provider server are encrypted.

7. The method of claim 1 further comprising:
prior to sending the compact metadata to the content intermediary client, delegating access rights of a user for accessing the content of the content provider server by:
sending to a content provider authorization service credentials of the content intermediary server and a request to delegate access rights of the user to the content intermediary server;
receiving from the authorization service authentication information for use by the user in authenticating with the authorization service; and
sending to the content intermediary client the received authentication information so that the content intermediary client can provide content provider credentials of the user directly to the authorization service and receive an authorization token indicating that the user is authorized to access content of the content provider server.

8. The method of claim 1 further comprising, prior to retrieving from the content provider server, receiving from the content intermediary client a refresh token and using the refresh token to retrieve an access token for use in retrieving from the content provider server.

9. A server for providing content to a client, comprising:
a computer-readable storage medium storing computer-executable instructions adapted to control the server to:
receive from the client a request for metadata for content instances;
retrieve from a content provider server metadata for content instances, the retrieved metadata having a metadata size;
generate compact metadata from the retrieved metadata, the compact metadata having a size that is smaller than the metadata size;
send the compact metadata via a restricted-bandwidth communication channel to the client;
receive from the client a request for content of a specified content instance;
retrieve from the content provider server content for the specified content instance, the retrieved content having a content size;
generate compact content from the retrieved content, the compact content having a size that is smaller than the content size; and
send the compact content via the restricted-bandwidth communication channel to the client; and
a processor for executing the computer-executable instructions.

10. The server of claim 9 wherein the instructions that generate the compact metadata are adapted to extract values for key attributes of the retrieved metadata and compress the extracted values.

11. The server of claim 9 wherein the instructions that generate the compact content are adapted to compress the retrieved content.

12. The server of claim 9 wherein communications between the server and the client and between the server and the content provider server are encrypted.

13. The server of claim 9 wherein the instructions are further adapted to control the server to, prior to sending the compact metadata to the client, delegating access rights of a user for accessing the content of the content provider server.

14. The server of claim 9 wherein the instructions are further adapted to control the server to send to an authorization service credentials of the server and a request to delegate access rights of a user to the server, receive from the authorization service authentication information for use by the user in authenticating with the authorization service, and send to the client the received authentication information so that the client can provide content provider credentials of the user directly to the authorization service and receive an authorization token indicating that the user is authorized to access content of the content provider server.

15. The server of claim 9 wherein the instructions are further adapted to control the server to, prior to retrieving from the content provider server, receive from the client a refresh token and use the refresh token to retrieve an access token for use in retrieving from the content provider server.

16. A method performed by a client for accessing content, the method comprising:
sending to a content intermediary server a request for metadata of a content provider that includes content intermediary credentials and content provider identification information of a user and an authorization token;
receiving from the content intermediary server compact metadata of content instances;
presenting to the user metadata of the content instances; and
in response to a user specification of a content instance,
sending to the content intermediary server a request for content of the specified content instance that includes content intermediary credentials and content provider identification information of the user and an authorization token;
receiving from the content intermediary server compact content of the specified content instance; and
presenting to the user the compact content.

17. The method of claim 16 further comprising:
sending to the content intermediary server a request to delegate access rights of the user to the content intermediary server that includes content intermediary credentials and content provider identification information of the user;
receiving from the content intermediary server authentication information;
sending content provider credentials to an authorization service as indicated by the authentication information; and
receiving from the authorization service the authorization token.

18. The method of claim 16 wherein the authorization token is a refresh token.

19. The method of claim 16 wherein the client and the content intermediary server communicate via a restricted-bandwidth communication channel.

20. The method of claim 16 including persistently storing the compact metadata and the compact content.

21. A server for providing content to a client, comprising:
a computer-readable storage medium storing computer-executable instructions adapted to control the server to:
send to a client compact metadata generated from metadata retrieved from a content provider server, the metadata describing content instances of the content provider server; and
in response to receiving from the client a request for content of a specified content instance, send to the client compact content generated from content of the specified content instance retrieved from the content provider server; and
a processor for executing the computer-executable instructions.
